(19) United States
(12) Patent Application Publication
(10) Pub. No.: US 2016/0034143 A1
(43) Pub. Date: Feb. 4, 2016

(54) NAVIGATING DIGITAL CONTENT BY TILT GESTURES

(71) Applicant: Flipboard, Inc., Palo Alto, CA (US)

(72) Inventor: Vaibhav Sharma, Mountain View, CA (US)

(21) Appl. No.: 14/445,487

(22) Filed: Jul. 29, 2014

(51) Int. Cl. G06F 3/0484; G06F 3/01; G06F 3/0488; H04L 29/08

(52) U.S. Cl. CPC G06F 3/04842; H04L 67/306; G06F 3/017; G06F 3/04883

(57) ABSTRACT

A digital magazine application executing on a client device enables a user of the client device to view and navigate digital content. The digital magazine application detects tilt gestures based on changes in orientation of the client device detected by an orientation sensor of the client device. When a tilt gesture is detected, the digital magazine application identifies a direction of the tilt gesture and selects content for presentation based on the tilt gesture and its direction. Hence, the digital magazine application simplifies navigation between content presented by the client device, allowing a user of the client device to navigate among content by changing the orientation of the client device.

### BACKGROUND

This disclosure relates generally to navigating digital content, and in particular to navigating digital content using tilt gestures received by a mobile device.

The use of mobile devices to interact with digital content is becoming increasingly more common. These mobile devices, including tablets and mobile phones, allow consumers to interact with content from nearly any location. Additionally, because of their portability, mobile devices are often more convenient to use for content interaction than traditional desktop or laptop computers. While mobile devices provide a convenient mechanism for accessing content, the input devices used by many mobile devices may make it difficult to navigate among content presented using the mobile devices.

### SUMMARY

An application executing on a client device, such as a mobile device, displays digital content to a user. As a user interacts with the digital content on the mobile device, the application receives tilt gestures via one or more orientation sensors of the mobile device and navigates the digital content based on the received tilt gestures. The application receives information about an orientation of the mobile device from an orientation sensor, such as an accelerometer or a gyroscope. When at least a threshold motion of the mobile device is determined from the information about the mobile device's orientation, such as a threshold angle of rotation or a threshold acceleration, the application identifies a tilt gesture. The application determines a navigation action associated with the tilt gesture and performs the navigation action. In one embodiment, the application associates different navigation actions with different tilt gestures and performs different navigation actions when different tilt gestures are identified. For example, the application selects different pages of content for presentation depending on a direction of each identified tilt gesture.

In one embodiment, the application executing on the mobile device is a digital magazine application, and the digital content includes a hierarchy of feeds of a digital magazine, with each feed including a plurality of articles or other content items. By tilting the mobile device, moving the mobile device in various directions, or a combination of such motions, a user may navigate the feeds of the digital magazine, access additional portions of a content item being presented, access additional functionality of the digital magazine application, or otherwise navigate content of the digital magazine. Navigating content based on tilt gestures determined from one or more orientation sensors of the client device allows a user to consume the content of the digital magazine through single-handed interaction with the client device.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is a block diagram of a system environment in which a digital magazine server operates, according to one embodiment.

FIG. 2 is a block diagram of a digital magazine server, according to one embodiment.

FIG. 3 is an example of presentation of content items in a digital magazine using a page template, according to one embodiment.

FIG. 4 is a block diagram illustrating components of a mobile device, according to one embodiment.

FIGS. 5A-B illustrate examples of tilt gestures for navigating digital magazine content, according to one embodiment.

FIG. 6 is a flowchart illustrating a method for navigating digital content, according to one embodiment.

FIG. 7 is an example of navigating digital content by tilt gestures, according to one embodiment.

FIG. 8 is another example of navigating digital content by tilt gestures, according to one embodiment.

FIG. 9 is another example of navigating digital content by tilt gestures, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Overview

A digital magazine server retrieves content from one or more sources and generates a personalized, customizable digital magazine for a user based on the retrieved content. The generated digital magazine is retrieved by a digital magazine application executing on a computing device (such as a mobile communication device, a tablet, or any other suitable computing system) and presented to the user. For example, based on selections made by the user and/or on behalf of the user, the digital magazine server generates a digital magazine including one or more sections including content items retrieved from a number of sources and personalized for the user. The generated digital magazine allows the user to more easily consume content that interests and inspires the user by presenting content items in an easily navigable interface via a mobile computing device.

The digital magazine may be organized into a number of sections that each include content having a common characteristic (e.g., content obtained from a particular source). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

System Architecture

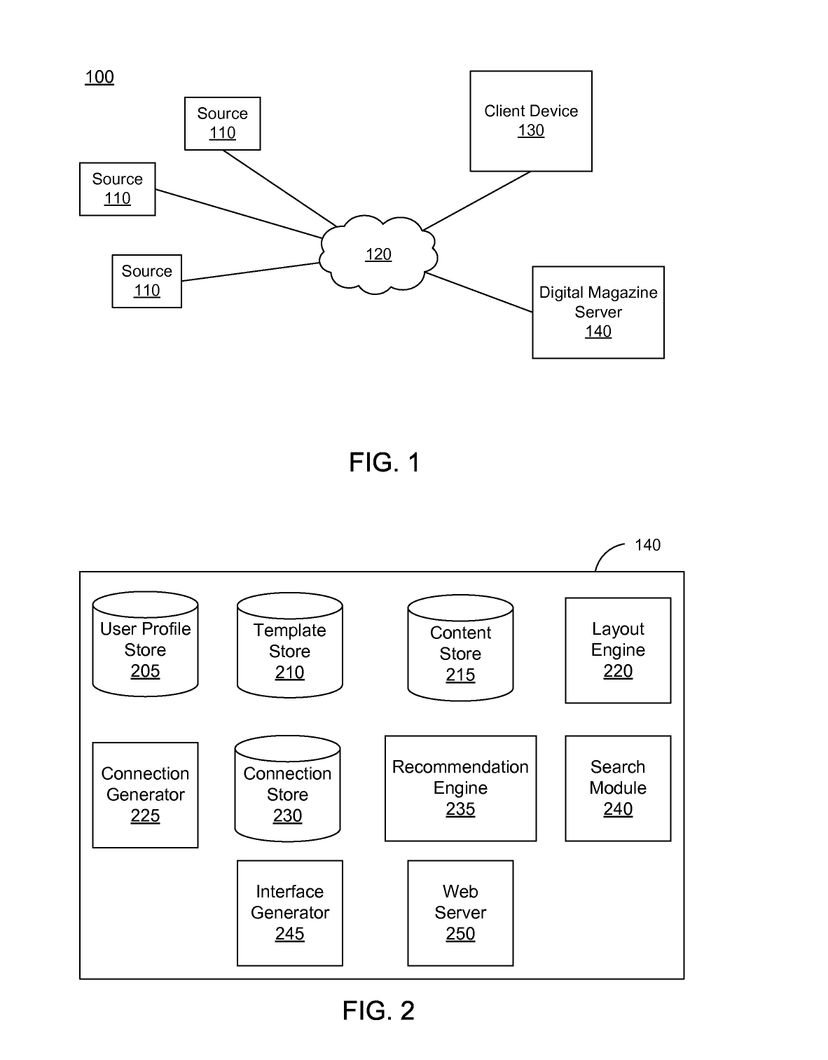

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. The embodiments described herein can be adapted to online systems that are not digital magazine severs 140.

A source 110 is a computing system capable of providing various types of content to a client device 130. Examples of content provided by a source 110 include text, images, video, or audio on web pages, web feeds, social networking information, messages, or other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” A content item may include various types of content, such as text, images, and video.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

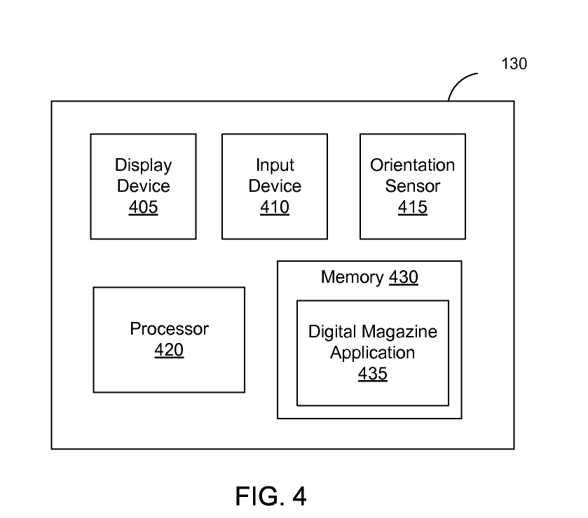

The client device 130 is one or more computing devices capable of receiving user input as well as transmitting and/or receiving data via the network 120. The client device 130 is a device having computer functionality, such as a personal digital assistant (PDA), a mobile telephone, a smartphone, or another suitable device, which l allows users to interact with the digital magazine server 140. The client device 130 retrieves pages of content from the digital magazine server 140 in response to user inputs received at the client device 130. In one embodiment, the client device 130 receives changes in orientations of the device as inputs to navigate content of the digital magazine server 140. These changes in orientation are referred to herein as “tilt gestures,” and include rotations of the client device 130 around axes perpendicular to the gravitational axis and accelerations of the client device 130. A client device 130 configured to navigate digital content in response to tilt gestures is further described in conjunction with FIG. 4. While FIG. 1 shows a single client device 130, in various embodiments, any number of mobile devices 130 may communicate with the digital magazine server 140.

The digital magazine server 140 receives content items from one or more sources 110, generates pages in a digital magazine by processing the received content, and provides the pages to the client device 130. As further described below in conjunction with FIG. 2, the digital magazine server 140 generates one or more pages for presentation to a user based on content items obtained from one or more sources 110 and information describing organization and presentation of content items. For example, the digital magazine server 140 determines a page layout specifying positioning of content items relative to each other based on information associated with a user and generates a page including the content items arranged according to the determined layout for presentation to the user via the client device 130. This allows the user to access content items via the client device 130 in a format that enhances the user's interaction with and consumption of the content items. For example, the digital magazine server 140 provides a user with content items in a format similar to the format used by print magazines. By presenting content items in a format similar to a print magazine, the digital magazine server 140 allows a user to interact with content items from multiple sources 110 via the client device 130 with less inconvenience from horizontally or vertically scrolling to access various content items.

FIG. 2 is a block diagram of an architecture of the digital magazine server 140. The digital magazine server 140 shown in FIG. 2 includes a user profile store 205, a template store 210, a content store 215, a layout engine 220, a connection generator 225, a connection store 230, a recommendation engine 235, a search module 240, an interface generator 245, and a web server 250. In other embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

Each user of the digital magazine server 140 is associated with a user profile, which is stored in the user profile store 205. A user profile includes declarative information about the user that was explicitly shared by the user and may also include profile information inferred by the digital magazine server 140. In one embodiment, a user profile includes multiple data fields, each describing one or more attributes of the corresponding social networking system user. Examples of information stored in a user profile include biographic, demographic, and other types of descriptive information, such as gender, hobbies or preferences, location, or other suitable information. A user profile in the user profile store 205 also includes data describing interactions by a corresponding user with content items presented by the digital magazine server 140. For example, a user profile includes a content item identifier, a description of an interaction with the content item corresponding to the content item identifier, and a time when the interaction occurred.

While user profiles in the user profile store 205 are frequently associated with individuals, allowing individuals to provide and receive content items via the digital magazine server 140, user profiles may also be stored for entities such as businesses or organizations. This allows an entity to provide or access content items via the digital magazine server 140. An entity may post information about itself, about its products, or provide other content items associated with the entity to users of the digital magazine server 140. For example, users of the digital magazine server 140 may receive a digital magazine or section including content items associated with an entity via the digital magazine server 140.

The template store 210 includes page templates each describing a spatial arrangement (“layout”) of content items relative to each other on a page for presentation by a client device 130. A page template includes one or more slots, each configured to present one or more content items. In some embodiments, slots in a page template may be configured to present a particular type of content item or to present a content item having one or more specified characteristics. For example, a slot in a page template is configured to present an image while another slot in the page template is configured to present text data. Each slot has a size (e.g., small, medium, or large) and an aspect ratio. One or more page templates may be associated with types of client devices 130, allowing content items to be presented in different relative locations and with different sizes when the content items are viewed using different client devices 130. Additionally, page templates may be associated with sources 110, allowing a source 110 to specify the format of pages presenting content items received from the source 110. For example, an online retailer is associated with a page template to allow the online retailer to present content items via the digital magazine server 140 with a specific organization. Examples of page templates are further described in U.S. patent application Ser. No. 13/187,840, filed on Jul. 21, 2011, which is hereby incorporated by reference in its entirety.

The content store 215 stores objects that each represent various types of content. For example, the content store 215 stores content items received from one or more sources 115 within a threshold time of a current time. Examples of content items stored by the content store 215 include a page post, a status update, a photograph, a video, a link, an article, video data, audio data, a check-in event at a location, or any other type of content. A user may specify a section including content items having a common characteristic, and the common characteristic is stored in the content 215 store along with an association with the user profile or the user specifying the section.

The layout engine 220 retrieves content items from one or more sources 110 or from the content store 215 and generates a page including the content items based on a page template from the template store 210. Based on the retrieved content items, the layout engine 220 may identify candidate page templates from the template store 210, score the candidate page templates based on characteristics of the slots in different candidate page templates and based on characteristics of the content items. Based on the scores associated with candidate page templates, the layout engine 220 selects a page template and associates the retrieved content items with one or more slots to generate a page where the retrieved content items are presented relative to each other and sized based on their associated slots. When associating a content item with a slot, the layout engine 220 may associate the content item with a slot configured to present a specific type of content item or to present content items having one or more specified characteristics. An example of using a page template to present content items is further described in U.S. patent application Ser. No. 13/187,840, filed on Jul. 21, 2011, which is hereby incorporated by reference in its entirety.

The connection generator 225 monitors interactions between users and content items presented by the digital magazine server 140. Based on the interactions, the connection generator 225 determines connections between various content items, connections between users and content items, or connections between users of the digital magazine server 140. For example, the connection generator 225 identifies when users of the digital magazine server 140 provide feedback about a content item, access a content item, share a content item with other users, or perform other actions with content items. In some embodiments, the connection generator 225 retrieves data describing user interaction with content items from the user's user profile in the user profile store 205. Alternatively, user interactions with content items are communicated to the connection generator 225 when the interactions are received by the digital magazine server 140. The connection generator 225 may account for temporal information associated with user interactions with content items. For example, the connection generator 225 identifies user interactions with a content item within a specified time interval or applies a decay factor to identified user interactions based on times associated with interactions. The connection generator 225 generates a connection between a user and a content item if the user's interactions with the content item satisfy one or more criteria. In one embodiment, the connection generator 225 determines one or more weights specifying a strength of the connection between the user and the content item based on user interactions with the content item that satisfy one or more criteria. Generation of connections between a user and a content item is further described in U.S. patent application Ser. No. 13/905,016, filed on May 29, 2013, which is hereby incorporated by reference in its entirety.

If multiple content items are connected to a user, the connection generator 225 establishes implicit connections between each of the content items connected to the user. In one embodiment, the connection generator 225 maintains a user content graph identifying the implicit connections between content items connected to a user. In one embodiment, weights associated with connections between a user and content items are used to determine weights associated with various implicit connections between content items. User content graphs for multiple users of the digital magazine server 140 are combined to generate a global content graph describing connections between various content items provided by the digital magazine server 140 based on user interactions with various content items. For example, the global content graph is generated by combining user content graphs based on mutual connections between various content items in user content graphs.

In one embodiment, the connection generator 225 generates an adjacency matrix from the global content graph or from multiple user content graphs and stores the adjacency matrix in the connection store 230. The adjacency matrix describes connections between content items. For example, the adjacency matrix includes identifiers of content items and weights representing the strength or closeness of connections between content items based on the global content graph. As an example, the weights indicate a degree of similarity in subject matter or similarity of other characteristics associated with various content items. In other embodiments, the connection store 230 includes various adjacency matrices determined from various user content graphs; the adjacency matrices may be analyzed to generate an overall adjacency matrix for content items provided by the digital magazine server 140. Graph analysis techniques may be applied to the adjacency matrix to rank content items, to recommend content items to a user, or to otherwise analyze relationships between content items. An example of the adjacency matrix is further described in U.S. patent application Ser. No. 13/905,016, filed on May 29, 2013, which is hereby incorporated by reference in its entirety.

In addition to identifying connections between content items, the connection generator 225 may also determine a social proximity between users of the digital magazine server 140 based on interactions between users and content items. The digital magazine server 140 determines social proximity, or “social distance,” between users using a variety of techniques. For example, the digital magazine server 140 analyzes additional users connected to each of two users of the digital magazine server 140 within a social networking system to determine the social proximity of the two users. In another example, the digital magazine server 140 determines social proximity between a first and a second user by analyzing the first user's interactions with content items posted by the second user, whether the content item is posted using the digital magazine server 140 or on another social networking system. Additional examples for determining social proximity between users of the digital magazine server 140 are described in U.S. patent application Ser. No. 13/905,016, filed on May 29, 2013, which is incorporated by reference in its entirety. In one embodiment, the connection generator 225 determines a connection confidence value between a user and an additional user of the digital magazine server 140 based on the user's and the additional user's common interactions with particular content items. The connection confidence value may be a numerical score representing a measure of closeness between the user and the additional user. For example, a larger connection confidence value indicates a greater similarity between the user and the additional user. In one embodiment, if a user has at least a threshold connection confidence value with another user, the digital magazine server 140 stores a connection between the user and the additional user in the connection store 230.

Using data from the connection store 230, the recommendation engine 235 identifies content items from one or more sources 110 for recommending to a digital magazine server user. Hence, the recommendation engine 235 identifies content items potentially relevant to a user. In one embodiment, the recommendation engine 235 retrieves data describing interactions between a user and content items from the user's user profile and data describing connections between content items, and/or connections between users from the connection store 230. In one embodiment, the recommendation engine 235 uses stored information describing content items (e.g., topic, sections, subsections) and interactions between users and various content items (e.g., views, shares, saved, links, topics read, or recent activities) to identify content items that may be relevant to a digital magazine server user. For example, content items having an implicit connection of at least a threshold weight to a content item with which the user interacted are recommended to the user. As another example, the recommendation engine 235 presents a user with content items having one or more attributes in common with a content item with which an additional user having a threshold connection confidence score with the user interacted. Recommendations for additional content items may be presented to a user when the user views a content item using the digital magazine, may be presented as a notification to the user by the digital magazine server 140, or may be presented to the user through any suitable communication channel.

In one embodiment, the recommendation engine 235 applies various filters to content items received from one or more sources 110 or from the content store 215 to efficiently provide a user with recommended content items. For example, the recommendation engine 235 analyzes attributes of content items in view of characteristics of a user retrieved from the user's user profile. Examples of attributes of content items include a type (e.g., image, story, link, video, audio, etc.), a source 110 from which a content item was received, time when a content item was retrieved, and subject matter of a content item. Examples of characteristics of a user include biographic information about the user, users connected to the user, and interactions between the user and content items. In one embodiment, the recommendation engine 235 analyzes attributes of content items in view of a user's characteristics for a specified time period to generate a set of recommended content items. The set of recommended content items may be presented to the user or may be further analyzed based on user characteristics and on content item attributes to generate more refined set of recommended content items. A setting included in a user's user profile may specify a length of time that content items are analyzed before identifying recommended content items to the user, allowing a user to balance refinement of recommended content items with time used to identify recommended content items.

The search module 240 receives a search query from a user and retrieves content items from one or more sources 110 based on the search query. For example, content items having at least a portion of an attribute matching at least a portion search query are retrieved from one or more sources 110. The user may specify sources 110 from which content items are received through settings maintained by the user's user profile or by identifying one or more sources in the search query. In one embodiment, the search module 240 generates a section of the digital magazine including the content items identified based on the search query, as the identified content items have a common attribute of their association with the search query. Presenting identified content items identified from a search query allows a user to more easily identify additional content items at least partially matching the search query when additional content items are provided by sources 110.

To more efficiently identify content items based on search queries, the search module 240 may index content items, groups (or sections) of content items, and user profile information. In one embodiment, the index includes information about various content items, such as author, source, topic, creation data/time, user interaction information, document title, or other information capable of uniquely identifying the content item. Search queries are compared to information maintained in the index to identify content items for presentation to a user. The search module 240 may present identified content items based on a ranking. One or more factors associated with the content items may be used to generate the ranking Examples of factors include: global popularity of a content item among users of the digital magazine server 140, connections between users interacting with a content item and the user providing the search query, and information from a source 110. Additionally, the search module 240 may assign a weight to the index information associated with each content item selected based on similarity between the index information and a search query and rank the content items based on their weights. For example, content items identified based on a search query are presented in a section of the digital magazine in an order based in part on the ranking of the content items.

To increase user interaction with the digital magazine, the interface generator 245 maintains instructions associating received input with actions performed by the digital magazine server 140 or by a digital magazine application executing on a client device 130. For example, instructions maintained by the interface generator 245 associate types of inputs or specific inputs received via an input device of a client device 130 with modifications to content presented by a digital magazine. As an example, if the input device is a touch-sensitive display, the interface generator 245 includes instructions associating different touch gestures with navigation through content items presented via a digital magazine. As another example, if the input device is an orientation sensor, the interface generator 245 includes instructions associating different tilt gestures with navigation through content items presented via the digital magazine. Instructions from the interface generator 245 are communicated to a digital magazine application or other application executing on a client device 130 on which content from the digital magazine server 140 is presented. Inputs received via an input device of the client device 130 are processed based on the instructions when content items are presented via the digital magazine server 140 is presented to simplify user interaction with content presented by the digital magazine server 140.

The web server 250 links the digital magazine server 140 via the network 120 to the one or more client devices 130, as well as to the one or more sources 110. The web server 250 serves web pages, as well as other content, such as JAVA®, FLASH®, XML and so forth. The web server 250 may retrieve content item from one or more sources 110. Additionally, the web server 250 communicates instructions for generating pages of content items from the layout engine 220 and instructions for processing received input from the interface generator 245 to a client device 130 for presentation to a user. The web server 250 also receives requests for content or other information from a client device 130 and communicates the request or information to components of the digital magazine server 140 to perform corresponding actions. Additionally, the web server 250 may provide application programming interface (API) functionality to send data directly to native client device operating systems, such as IOS®, ANDROID™, WEBOS®, or BlackberryOS.

For purposes of illustration, FIG. 2 describes various functionalities provided by the digital magazine server 140. However, in other embodiments, the above-described functionality may be provided by a digital magazine application executing on a client device 130, or may be provided by a combination of the digital magazine server 140 and a digital magazine application executing on a client device 130. For example, while the interface generator 245 is described above as including instructions associating different tilt gestures with navigation through content items, the client device 130 may alternatively execute instructions for analyzing tilt gestures to navigate through content items. In other cases, instructions for navigating through content items in response to identified tilt gestures are executed by both the digital magazine server 140 and the client device 130.

Page Templates

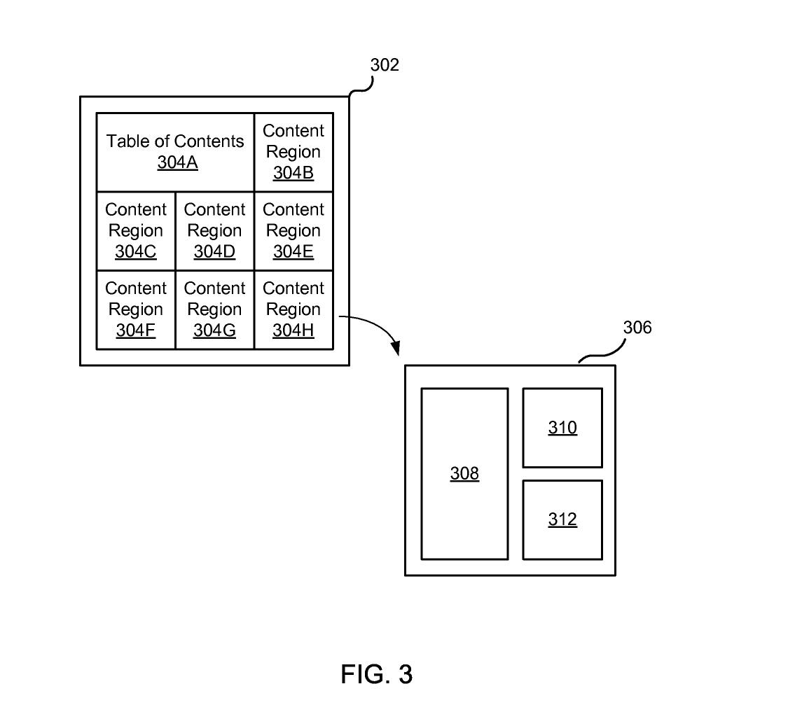

FIG. 3 illustrates an example page template 302 having multiple rectangular slots each configured to present a content item. Other page templates with different configurations of slots may be used by the digital magazine server 140 to present one or more content items received from sources 110. As described above in conjunction with FIG. 2, in some embodiments, one or more slots in a page template are reserved for presentation of content items having specific characteristics or for presentation of a specific type of content item. In one embodiment, the size of a slot may be specified as a fixed aspect ratio or using fixed dimensions. Alternatively, the size of a slot may be flexible, where the aspect ratio or one or more dimensions of a slot is specified as a range, such as a percentage of a reference or a base dimension. Arrangement of slots within a page template may also be hierarchical. For example, a page template is organized hierarchically, where an arrangement of slots may be specified for the entire page template or for one or more portions of the page template.

In the example of FIG. 3, when a digital magazine server 140 generates a page for presentation to a user, the digital magazine server 140 populates slots in a page template 302 with content items. Information identifying the page template 302 and associations between content items and slots in the page template 302 is stored and used to generate the page. For example, to present a page to a user, the layout engine 220 identifies the page template 102 from the template store 210 and retrieves content items from one or more sources 110 or from the content store 215. The layout engine 220 generates data or instructions associating content items with slots within the page template 302. Hence, the generated page includes various “content regions” presenting one or more content items associated with a slot in a location specified by the slot.

A content region 304 may present image data, text, data, a combination of image and text data, or any other information retrieved from a corresponding content item. For example, in FIG. 3, the content region 304A represents a table of contents identifying sections of a digital magazine, and content associated with the various sections are presented in content regions 304B-304H. For example, content region 304A includes text or other data indicating that the presented data is a table of contents, such the text “Cover Stories Featuring,” followed by one or more identifiers associated with various sections of the digital magazine. In one embodiment, an identifier associated with a section describes a characteristic common to at least a threshold number of content items in the section. For example, an identifier refers to the name of a user of social network from which content items included in the section are received. As another example, an identifier associated with a section specifies a topic, an author, a publisher (e.g., a newspaper, a magazine) or other characteristic associated with at least a threshold number of content items in the section. Additionally, an identifier associated with a section may further specify content items selected by a user of the digital magazine server 140 and organized as a section. Content items included in a section may be related topically and include text and/or images related to the topic.

Sections may be further organized into subsections, with content items associated with one or more subsections presented in content regions. Information describing sections or subsections, such as a characteristic common to content items in a section or subsection, may be stored in the content store 215 and associated with a user profile to simplify generation of a section or subsection for the user. A page template associated with a subsection may be identified, and slots in the page template associated with the subsection used to determine presentation of content items from the subsection relative to each other. Referring to FIG. 3, the content region 304H includes a content item associated with a newspaper to indicate a section including content items retrieved from the newspaper. When a user interacts with the content region 304, a page template associated with the section is retrieved, as well as content items associated with the section. Based on the page template associated with the section and the content items, the digital magazine server 140 generates a page presenting the content items based on the layout described by the slots of the page template. For example, in FIG. 3, the section page 306 includes content regions 308, 310, 312 presenting content items associated with the section. The content regions 308, 310, 312 may include content items associated with various subsections including content items having one or more common characteristics (e.g., topics, authors, etc.). Hence, a subsection may include one or more subsections, allowing hierarchical organization and presentation of content items by a digital magazine.

Client Device

As described above in connection with FIG. 1, the client device 130 retrieves content from the digital magazine server 140 and displays the content to a user. As the user interacts with the digital magazine content, the client device 130 receives tilt gestures as inputs to navigate the digital magazine content. FIG. 4 is a block diagram illustrating components of one embodiment of the client device 130. The example client device 130 shown in FIG. 4 includes a display device 405, an input device 410, an orientation sensor 415, a memory 430, and a processor 430. Other embodiments of the client device 130 may include different and/or additional components.

The display device 405 presents content items to a user of the client device 130. Examples of the display device 405 include a liquid crystal display (LCD), an organic light emitting diode (OLED) display, an active matrix liquid crystal display (AMLCD), or any other suitable device. Different client devices 130 may have display devices 405 with different characteristics. For example, different client devices 130 have display devices 405 with different display areas, different resolutions, or differences in other characteristics.

The input device 410 receives input from the user. Different input devices 410 may be included in the client device 130. For example, the client device 130 includes a touch-sensitive display for receiving input data, commands, or information from a user. Using a touch-sensitive display allows the client device 130 to combine the display device 405 and an input device 410. In other embodiments, the client device 130 may include a keyboard, a trackpad, a mouse, or any other device capable of receiving input from a user. In another example, the input device 410 is configured to receive information from a user of the client device 130 through a touchless interface. Examples of a touchless interface include sensors, such as an image capture device, to receive gestures from a mobile device user without the user physically contacting the display device 405 or the client device 130. Additionally, the client device 130 may include multiple input devices 410 in some embodiments.

The orientation sensor 415 detects an orientation of the client device 130 or a change in orientation of the client device 130. Examples of the orientation sensor 415 include a multi-axis accelerometer or gyroscope, several single-axis accelerometers or gyroscopes, a combination of single- or multi-axis accelerometers and gyroscopes, or other sensors capable of detecting orientation of the client device 130. The orientation sensor 415 outputs one or more signals indicative of a magnitude of acceleration of the client device 130 in various directions (including a magnitude of gravitational acceleration acting along axes of the client device 130) or a rate of rotation of the client device 130.

The processor 420 is a hardware component that retrieves and executes instructions, and outputs processed data as a result of the execution of instructions. Although a single processor 420 is shown in FIG. 4, the client device 130 may include multiple processors 420. Furthermore, the processor 420 may include more than one processing core to increase the capacity and speed of data processing.

The memory 430 stores instructions and data used by the processor 420. In particular, the memory 430 stores instructions that, when executed by the processor 420, perform various functions allowing users to view and interact with content provided by the digital magazine server 140. In one embodiment, the instructions executable by the processor 420 include instructions for a digital magazine application 435, which executes on an operating system of the client device 130 (e.g., IOS® or ANDROID™). In another embodiment, the instructions include instructions for a browser, which retrieves content from the digital magazine server 140 and presents the content to a user of the client device 130. In this case, the browser implements the functionality of the digital magazine application 435 described herein.

The digital magazine application 435 allows a user of the client device 130 to interact with the digital magazine server 140. The digital magazine application 435 receives content from the digital magazine server 140 and presents the received content to a user of the client device 130 via the display device 405. Inputs received via the input device 410 or orientation sensor 415 are processed based on instructions included in the digital magazine application 435 to identify one or more commands. The digital magazine application 435 communicates instructions or requests for content items to the digital magazine server 140 to modify content presented to a user of the client device 130 in response to commands identified from received inputs.

As users view and interact with digital content displayed by the client device 130, the processor 420 processes output signals of the orientation sensor 415 based on instructions included in the digital magazine application 435 to detect tilt gestures captured by the client device 130. Instructions included in the digital magazine application 435 associate commands for navigating through content items associated with various tilt gestures identified by the orientation sensor 415. In response to identifying a tilt gesture, the digital magazine application 435 generates a command for navigating content of the digital magazine server 140 associated with the identified tilt gesture.

A number of different tilt gestures may be used to navigate content provided by the digital magazine server 140. As described above, the digital magazine application 435 may include information associating different navigation commands with different tilt gestures. For example, the digital magazine application 435 includes navigation rules specifying navigation actions corresponding to respective tilt gestures. Each navigation rule specifies a type of navigation action associated with a tilt gesture. For example, content provided by the digital magazine is organized hierarchically into sections and sub-sections. The digital magazine application 435 navigates to a lower level in the hierarchy of content when certain tilt gestures are identified, navigates to a higher level in the hierarchy when other tilt gestures are identified, and navigates between items at the same level in the hierarchy when additional tilt gestures are identified. Using the stored navigation rules, the digital magazine application 435 determines content from the digital magazine server 140 to present based on a navigation action corresponding to an identified tilt gesture captured by the client device 130. For example, the digital magazine application 435 associates an identified tilt gesture with a navigation command to navigate to a lower level in a hierarchy of content provided by the digital magazine server 140 and requests content from the digital magazine server 140 associated with the lower level in the hierarchy than the content currently displayed by the client device 130.

In other cases, rather than request content from the digital magazine server 140, the digital magazine application 435 accesses content stored by the client device 130 based on an identified tilt gesture. For example, the client device 130 caches content from the digital magazine server 140, such as one or more pages of digital magazine content. When a tilt gesture is identified, the digital magazine application 435 retrieves content (e.g., a page of content) from the cached content and displays the retrieved content. In another example, the digital magazine application 435 interprets tilt gestures as inputs to navigate functionality of the digital magazine application 435, such as navigating between a content area, a settings menu, a table of contents, and other components of the digital magazine application 435. In this case, the digital magazine application 435 selects content from the digital magazine application 435 to present in response to identifying tilt gestures.

Alternatively, the digital magazine server 140 selects content for presentation by the client device 130 in response to tilt gestures received by the client device 130. In this case, the digital magazine application 435 communicates information describing a tilt gesture, such as a tilt direction from the tilt gesture, to the digital magazine server 140 with a content request. The digital magazine server 140 identifies a navigation action based on the information describing the tilt gesture, selects content based on the identified navigation action, and communicates the selected content to the client device 130 for presentation.

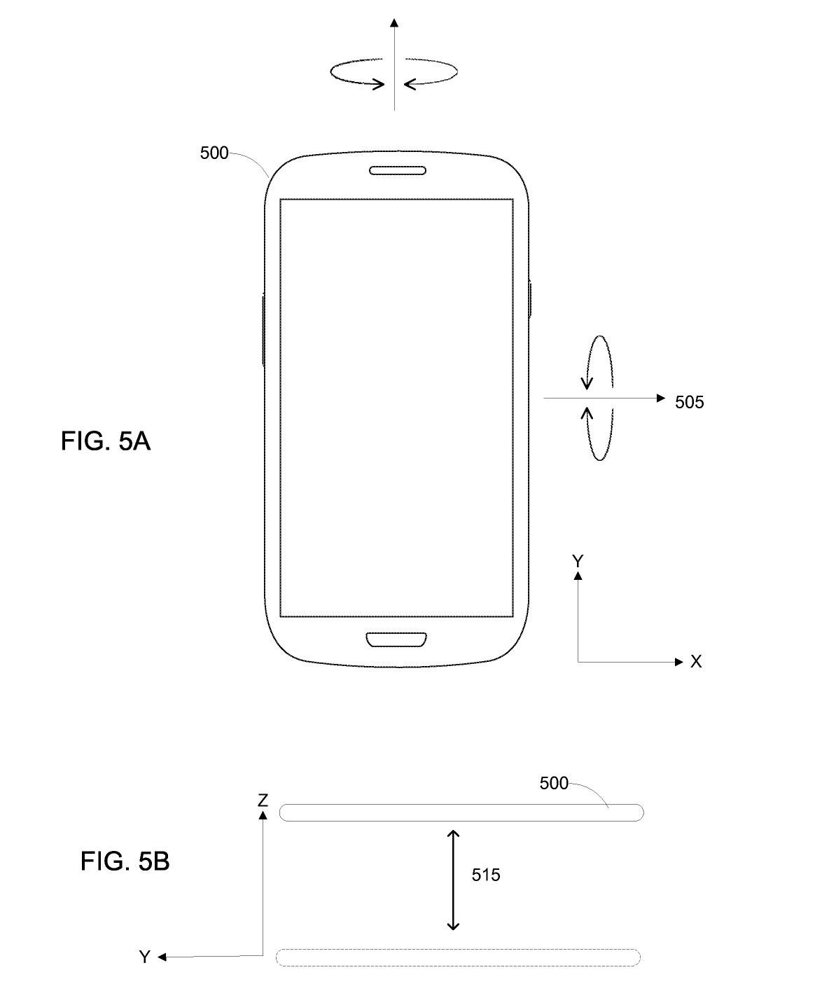

FIGS. 5A-5B illustrate examples of tilt gestures for navigating content provided by the digital magazine server 140. In FIGS. 5A and 5B, gravity acts along the z-axis. FIG. 5A illustrates a top view of a mobile phone 500 as an example client device 130, while FIG. 5B illustrates a side view of the mobile phone 500. When the mobile phone 500 is oriented perpendicular to gravity (i.e., in the x-y plane), the mobile phone 500 may be rotated around the x-axis 505 or around the y-axis 510, as shown in FIG. 5A. The mobile phone 500 may also be repositioned along one or more axes, with an acceleration corresponding to the repositioning along an axis. In the example of FIG. 5B, the mobile phone 500 is repositioned along the z-axis 515 to provide a tilt gesture. Various rotations about an axis or repositioning along an axis are interpreted by the mobile phone 500 based on instructions in the digital magazine application 435 as various commands to navigate content of the digital magazine server 140, and the digital magazine application 435 may perform different navigation actions for each unique tilt gesture. While the mobile phone 500 is shown in FIGS. 5A-B as being oriented in the x-y plane for simplicity, the mobile phone 500 may be similarly accelerated in any direction or rotated around the x- or y-axes (relative to a gravitational axis) while in other orientations.

Navigating Digital Content by Tilt Gestures

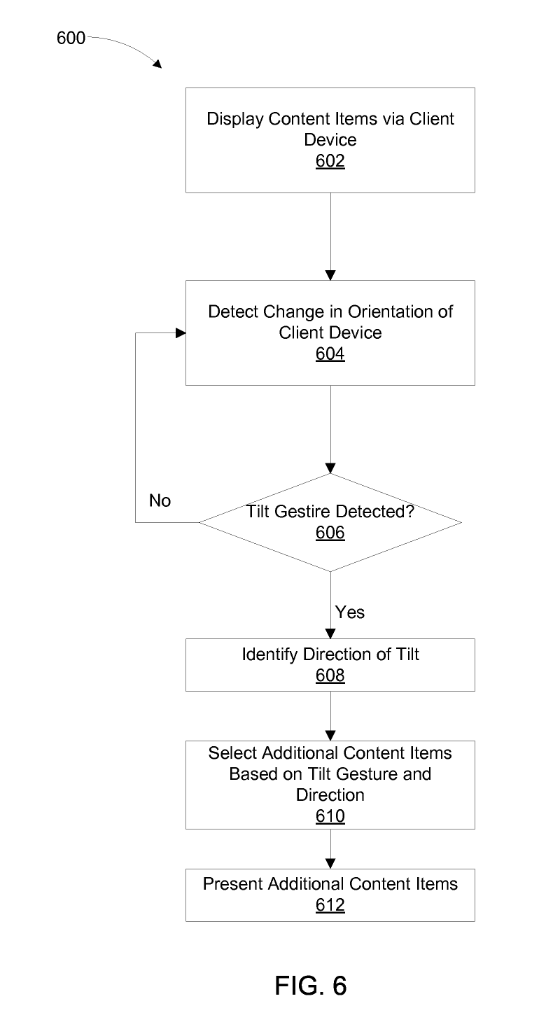

FIG. 6 is a flowchart illustrating a method 600 for navigating digital content, such as content of the digital magazine server 140, presented by a client device 130 using tilt gestures. In one embodiment, the steps of the method 600 are performed by the digital magazine application 435. Other embodiments may include different and/or additional steps, and may perform the steps in a different order. Although the embodiment of FIG. 6 is described herein with respect to using tilt gestures to navigate content of a digital magazine, other types of digital content may be navigated by similar methods. For example, the method 600 may be used to navigate any type of digital content displayed by a client device 130, whether the content is stored on the client device 130 or the client device 130 receives the content from an external computing device (such as a server).

Referring to FIG. 6, the digital magazine application 435 displays 602 one or more content items using the client device 130. For example, the digital magazine application 435 displays a page of content received from the digital magazine server 140. As a user accesses and interacts with the displayed content items, the digital magazine application 435 receives 604 orientation data from the orientation sensor 415 of the client device 130 and detects 604 a change in orientation of the client device 130 based on the orientation data. In one embodiment, the digital magazine application 435 monitors the orientation sensor 415 and determines a static orientation of the client device 130 based on the output of the orientation sensor 415. For example, the digital magazine application 435 determines whether the client device 130 is oriented perpendicularly to gravity or tilted at an angle relative to gravity. In another embodiment, the digital magazine application 435 monitors the orientation sensor 415 to detect 604 changes in orientation of the client device 130, such as rotations of the client device 130 around an axis or repositioning of the client device 130 along an axis.

Based on the detected change in orientation, the client device 130 determines 606 whether a tilt gesture is detected based on information specified by the digital magazine application 435. In one embodiment, a tilt gesture is detected if the detected change in orientation of the client device 130 exceeds a specified threshold angle or exceeds a threshold rate of motion. In this case, the digital magazine application 435 monitors the orientation sensor 415 to detect 604 a change in orientation of the client device 130. If the angle between an initial orientation and a final orientation of the device 130 exceeds the threshold angle, the client device 130 determines 606 a tilt gesture has occurred. In another embodiment, the digital magazine application 435 determines 606 a tilt gesture is detected based on the change in orientation of the client device 130 if the angular or linear acceleration of the client device 130 exceeds a specified threshold magnitude. Yet another embodiment of the digital magazine application 435 determines 606 a tilt gesture has been detected if both the angle and rate of rotation of the client device 130 exceed corresponding thresholds. For example, the client device 130 determines 606 a tilt gesture is detected if the client device 130 is rotated more than thirty degrees in less than one second. Yet another embodiment of the digital magazine application 435 determines 606 a tilt gesture has been detected if the client device 130 is rotated away from and back to its normal resting position through a threshold angle, at a threshold rate, in a certain period of time, or a combination thereof.

By comparing detected changes in orientation and position to threshold values to determine 606 whether a tilt gesture is detected, the digital magazine application 435 reduces unintended navigation through content items. For example, the digital magazine application 435 does not determine 606 a tilt gesture was detected in response to minor variations in orientation of the client device 130 (e.g., changes in orientation less than a threshold amount) caused by adjustments to the position of the client device 130, hand twitches of the user, and the like. In some cases, the threshold angle and/or threshold magnitude of acceleration are specified by the user of the digital magazine application 435. Alternatively, the threshold angle and/or magnitude are specified by one or more settings of the digital magazine application 435.

In one embodiment, the digital magazine application 435 determines 606 a tilt gesture is detected when an initial change in orientation exceeds a threshold value within a specified time period (e.g., 1-2 seconds), but does not detect subsequent rotations or movements of the client device 130 as tilt gestures. For example, a user rotates the client device 130 more than a threshold amount and returns the client device 130 to its original orientation within one second to be able to read the display. The digital magazine application 435 determines 606 the initial rotation is a tilt gesture, but does not determine 606 a tilt gesture was detected for the motion restoring the device to its original orientation.

If the digital magazine application 435 determines 606 a tilt gesture was detected, the digital magazine application 435 identifies 608 a direction of the tilt gesture based on data from the orientation sensor 415. In one embodiment, the digital magazine application 435 identifies the direction of tilt based on the magnitude of signals output from the orientation sensor 415. For example, if the orientation sensor 415 is a multi-axis accelerometer or multiple single-axis accelerometers, the digital magazine application 435 identifies 608 the direction of the accelerometer signal having the largest change as a direction of the tilt gesture. If the orientation sensor 415 is one or more gyroscopes, the digital magazine application 435 identifies 608 the direction of the largest gyroscope signal as the direction of the tilt gesture. In other cases, the digital magazine application 435 determines vector sums of accelerometer and/or gyroscope signals before and after the detected tilt gesture to identify 608 a direction of the detected tilt gesture.

Based on the detected tilt gesture and the direction of the tilt gesture, the digital magazine application 435 selects additional content items 610 and displays 612 the additional content items on the display device 405 of the client device 130. Selecting the additional content items based on the tilt gesture and the direction of the tilt gesture allows the digital magazine application 435 to display 612 different additional content items when different tilt gestures or different directions of tilt gestures are detected. In some cases, the digital magazine application 435 selects 610 the additional content items and requests the additional content items from the digital magazine server 140. Alternatively, the digital magazine application 435 communicates information describing the tilt gesture and the direction of the tilt gesture to the digital magazine server 140, which selects the additional content items based on the information and returns the additional content items to the digital magazine application 435 for display 612.

The digital magazine application 435 may retain information about the magnitude or rate at which the orientation of the client device 130 has changed to determine the magnitude or rate at which to display additional content items. For example, upon detecting a tilt gesture in a direction to turn a page of a digital magazine, the digital magazine application 435 can determine the rate at which the orientation of the device 130 has changed and animate the turning of the page at the same or proportional rate. In another example, upon detecting a tilt gesture in a direction to turn a page of a digital magazine, the digital magazine application 435 can determine the magnitude at which the orientation of the device 130 has changed, and if the magnitude is below a threshold, animate a partial turning of the page at the same or proportional magnitude to peek at the next content item, after which the page is not turned.

Displaying additional content items (e.g., an additional page of content from a digital magazine) in response to detecting a tilt gesture allows a user of a client device 130 executing the digital magazine application 435 to navigate content of the digital magazine server 140 by tilting the client device 130. As the user may tilt the client device 130 while holding the client device 130 in one hand, the digital magazine application 435 allows the user to consume content provided by the digital magazine server 140 while operating the client device 130 under conditions that are not conducive to traditional navigation. For example, a user may use tilt gestures to navigate content while operating the client device 130 with one hand or while wearing gloves.

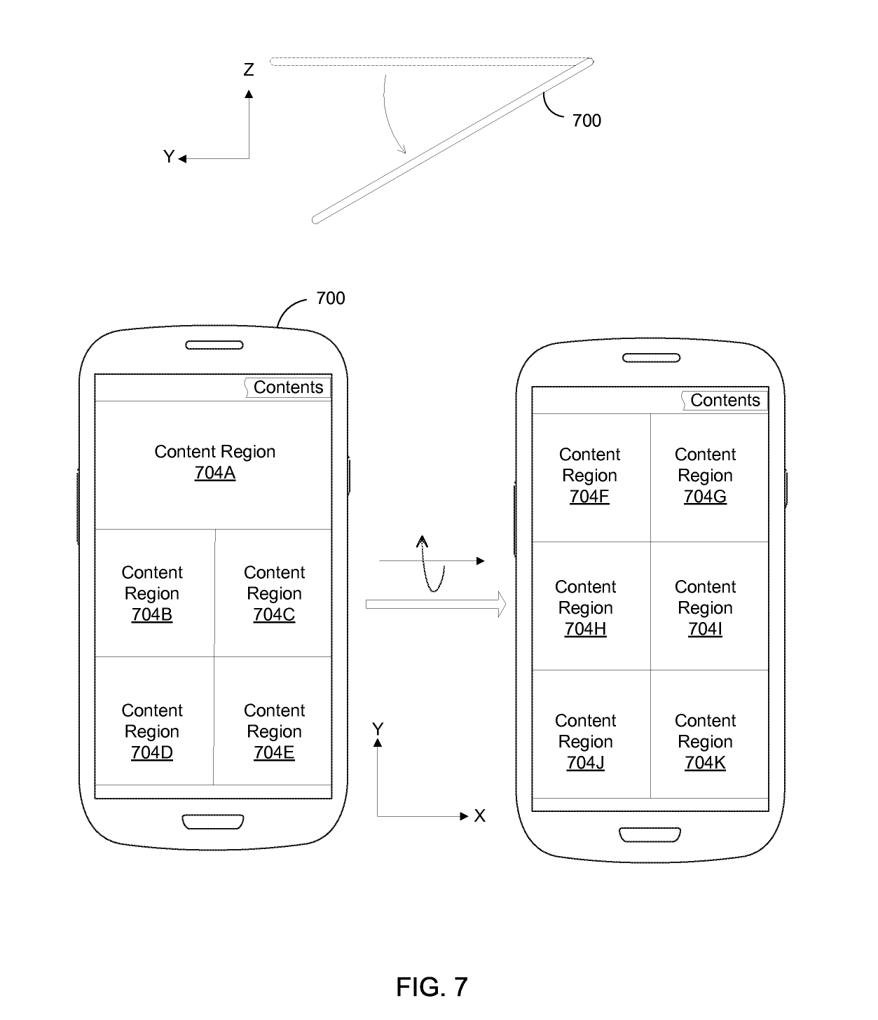

FIGS. 7-9 illustrate various examples of navigating digital content by tilt gestures. Specifically, FIGS. 7-9 illustrate navigating content of the digital magazine server 140 on a mobile phone 700 as an example of a client device 130. For simplicity, the illustrated examples show the mobile phone 700 oriented in an x-y plane, perpendicular to gravity. However, a user may use similar tilt gestures to navigate content of the digital magazine server 140 when the mobile phone 700 is oriented differently.

In the examples shown in FIGS. 7-9, content of the digital magazine server 140 is a digital magazine that is hierarchically organized into a plurality of sections. At a highest level in the hierarchy, pages of content displayed by the digital magazine application 435 include identifiers of the sections. If a user selects a section identifier, the digital magazine application 435 navigates to a lower level in the hierarchy by displaying content within the selected section, such as identifiers of articles within the section. If a user selects an article identifier, the digital magazine application 435 navigates to a lower level in the hierarchy by displaying pages of the article associated with the selected article identifier.

FIG. 7 illustrates an example tilt gesture to navigate between sections of the digital magazine. In FIG. 7, the mobile phone 700 initially displays a set of content regions 704A-E, each identifying a section of the digital magazine. For example, content region 704A identifies a cover stories section, content region 705B identifies a news section, content region 704C identifies a social network section, while content regions 705D-E identify other content sections. When the user of the mobile phone 700 tilts a top of the mobile phone 700 down, rotating the device around the x-axis shown in FIG. 7, the digital magazine application 435 determines the tilt gesture as an input to navigate to a next page of content regions 704F-K, which identify an additional set of digital magazine sections. Rotating the opposite direction around the x-axis (that is, tilting the bottom of the phone down) may navigate from the second page of content regions back to the first page of content regions. The digital magazine application 435 may interpret similar tilt gestures as inputs to navigate content items within a section of the digital magazine. For example, the user may rotate the mobile phone 700 around the x-axis to navigate between articles in a section, to navigate forward or backward within an article, and so forth. Thus, rotating the mobile device 700 around the x-axis allows the user of the mobile phone 700 to navigate between pages of the digital magazine content at the same level in the content hierarchy.

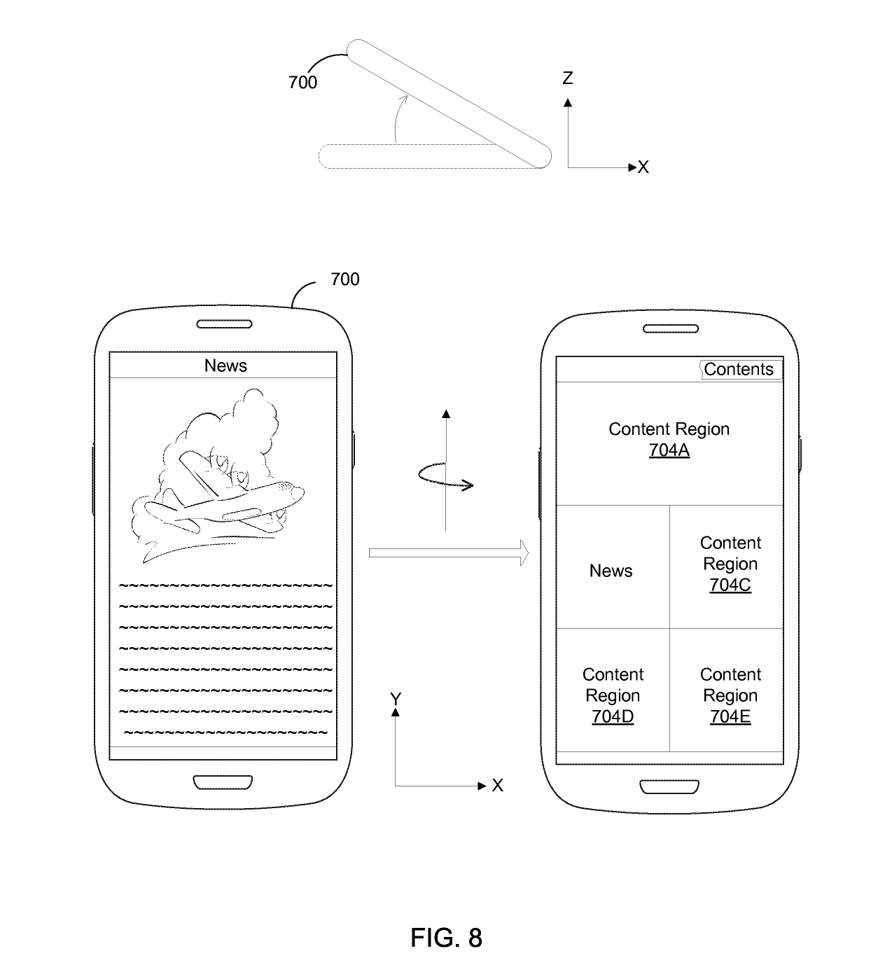

FIG. 8 illustrates an example tilt gesture to navigate a hierarchy of digital content. In FIG. 8, the user is accessing an article within a “News” section of the digital magazine via the mobile phone 700. When the user rotates the mobile phone 700 around the y-axis from left to right, the digital magazine application 435 interprets the determined tilt gesture as an input to navigate to a higher level in the hierarchy of the digital magazine. For example, the digital magazine application 435 displays a page of section identifiers in response to detecting the tilt gesture and direction shown in in FIG. 8. Rotating the opposite direction around the y-axis (that is, from right to left) may be used as an input to go to a lower level in the hierarchy of digital content. For example, if a content region displayed on the mobile phone 700 is an identifier of an article, the user rotates the mobile phone 700 from right to left to view the article itself.

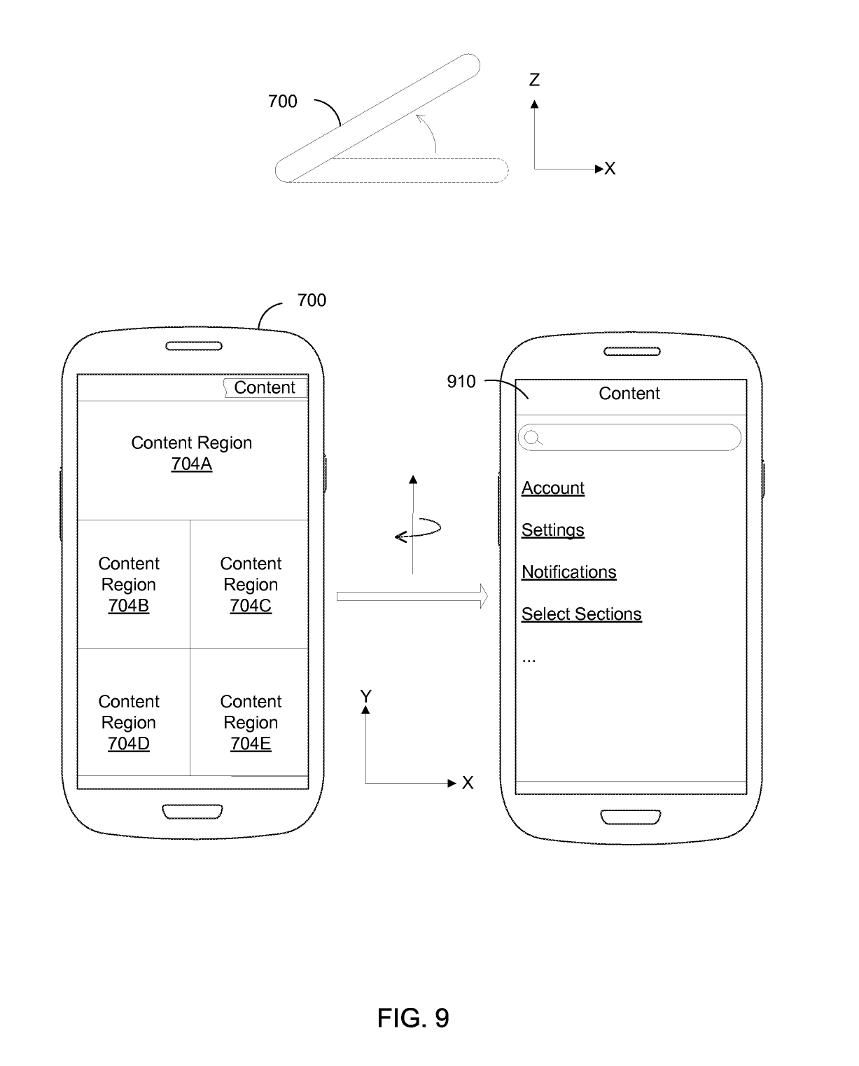

As another example, tilt gestures may be used to navigate functionality provided by the digital magazine application 435. FIG. 9 illustrates using a tilt gesture to navigate from a page of section identifiers, such as the section identifiers 704A-E, to a content menu 910 of the digital magazine application 435. Interacting with the menu items of the content menu 910, allows the user to manage its account on the digital magazine server 140, change settings of the digital magazine application 435, and so forth.

Numerous other navigation actions besides those illustrated in FIGS. 7-9 may be performed in response to detected tilt gestures and directions of tilt gestures. For example, movements along any axes can be used to navigate content. Movement along the z-axis toward and away from the user could resulting in zooming in and out, increasing or decreasing font size, or showing more or less detail about the content item (e.g., preview of article text, authorship, table of contents, or other metadata), respectively. Movement along the x-axis to the right or left can result in navigation to the next or previous content item, respectively. In another example, movement along one or more axes in a shaking motion could result in a command to share content items with other users of the digital magazine server 140 (e.g., adding a content item to a magazine, sending a content item to another user, reporting a content item as inappropriate, or inviting another user to contribute content items to the current magazine).

Moreover, other types of client devices 130 may execute the digital magazine application 435 and navigate content in response to tilt gestures. Navigation actions performed in response to various detected tilt gestures may differ on different types of client devices 130. For example, a tablet executing the digital magazine application 435 may perform different navigation actions than those shown in FIGS. 7-9 in response to analogous tilt gestures.

Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for navigating digital content, the method comprising:
displaying content items on a display device of a client device;
detecting a change in orientation of the client device based on data captured from an orientation sensor included in the client device;
determining a direction associated with the change in orientation of the client device;
selecting one or more additional content items based at least in part on the detected change in orientation of the client device and the direction associated with the change in orientation of the client device; and
displaying the one or more additional content items on the display device of the client device.

2. The method of claim 1, wherein detecting the change in orientation of the client device based on data captured from the orientation sensor included in the client device comprises:
receiving a signal from the orientation sensor indicating an acceleration of the client device along an axis; and
detecting the change in orientation of the client device if the acceleration of the client device is greater than a threshold acceleration.

3. The method of claim 1, wherein detecting the change in orientation of the client device based on data captured from the orientation sensor included in the client device comprises:
receiving a signal from the orientation sensor indicating a change in orientation of the mobile device relative to an axis; and
detecting the change in orientation of the client device if the change in orientation equals or exceeds a threshold angle.

4. The method of claim 3, wherein the threshold angle is specified by a user of the client device.

5. The method of claim 1, wherein detecting the change in orientation of the client device based on data captured from the orientation sensor included in the client device comprises:
receiving a signal from the orientation sensor indicating a change in orientation of the client device relative to an axis; and
detecting the change in orientation of the client device if a rate of the change in orientation of the client device relative to the axis is greater than a threshold rate of change.

6. The method of claim 1, wherein the content items and the additional content items are organized hierarchically, and wherein the additional content items have a lower level in a hierarchy than the content items.

7. The method of claim 1, wherein the content items and the additional content items are organized hierarchically, and wherein the additional content items have a higher level in a hierarchy than the content items.

8. The method of claim 1, wherein the content items and the additional content items are organized hierarchically, and wherein the additional content items and the content items have a common level within a hierarchy.

9. The method of claim 1, wherein selecting one or more additional content items based at least in part on the detected change in orientation of the client device and the direction associated with the change in orientation of the client device comprises:
identifying a navigation rule associated with the detected change in orientation of the client device and the direction associated with the change in orientation; and
selecting the one or more additional content items using the identified navigation rule corresponding to the identified tilt direction.

10. The method of claim 1, wherein selecting one or more additional content items based at least in part on the detected change in orientation of the client device and the direction associated with the change in orientation of the client device comprises:
communicating a request for content to a content sever, the request including information describing the detected change in orientation of the client device and the direction associated with the change in orientation of the client device; and
receiving the one or more additional content items from the content server, the one or more additional content items determined based at least in part the detected change in orientation of the client device and the direction associated with the change in orientation of the client device.

11. A computer program product comprising a non-transitory computer readable storage medium having instructions encoded thereon that, when executed by a processor, cause the processor to:
display content items on a display device of a client device;
detect a change in orientation of the client device based on data captured from an orientation sensor included in the client device;
determine a direction associated with the change in orientation of the client device;
select one or more additional content items based at least in part on the detected change in orientation of the client device and the direction associated with the change in orientation of the client device; and
display the one or more additional content items on the display device of the client device.

12. The computer program product of claim 11, wherein detect the change in orientation of the client device based on data captured from the orientation sensor included in the client device comprises:
receive a signal from the orientation sensor indicating an acceleration of the client device along an axis; and
detect the change in orientation of the client device if the acceleration of the client device is greater than a threshold acceleration.

13. The computer program product of claim 11, wherein detect the change in orientation of the client device based on data captured from the orientation sensor included in the client device comprises:
receive a signal from the orientation sensor indicating a change in orientation of the mobile device relative to an axis; and
detect the change in orientation of the client device if the change in orientation equals or exceeds a threshold angle.

14. The computer program product of claim 13, wherein the threshold angle is specified by a user of the client device.

15. The computer program product of claim 11, wherein detect the change in orientation of the client device based on data captured from the orientation sensor included in the client device comprises:
receive a signal from the orientation sensor indicating a change in orientation of the client device relative to an axis; and
detect the change in orientation of the client device if a rate of the change in orientation of the client device relative to the axis is greater than a threshold rate of change.

16. The computer program product of claim 11, wherein the content items and the additional content items are organized hierarchically, and wherein the additional content items have a lower level in a hierarchy than the content items.

17. The computer program product of claim 11, wherein the content items and the additional content items are organized hierarchically, and wherein the additional content items have a higher level in a hierarchy than the content items.

18. The computer program product of claim 11, wherein the content items and the additional content items are organized hierarchically, and wherein the additional content items and the content items have a common level within a hierarchy.

19. The computer program product of claim 11, wherein select one or more additional content items based at least in part on the detected change in orientation of the client device and the direction associated with the change in orientation of the client device comprises:
identify a navigation rule associated with the detected change in orientation of the client device and the direction associated with the change in orientation; and
select the one or more additional content items using the identified navigation rule corresponding to the identified tilt direction.

20. The computer program product of claim 11, wherein select one or more additional content items based at least in part on the detected change in orientation of the client device and the direction associated with the change in orientation of the client device comprises:
communicate a request for content to a content sever, the request including information describing the detected change in orientation of the client device and the direction associated with the change in orientation of the client device; and
receive the one or more additional content items from the content server, the one or more additional content items determined based at least in part the detected change in orientation of the client device and the direction associated with the change in orientation of the client device.
